(19) United States
(12) Patent Application Publication
(10) Pub. No.: US 2002/0140656 A1
(43) Pub. Date: Oct. 3, 2002

(54) Liquid crystal display device and method of adjusting the same

(76) Inventor: Yuka Yoshioka, Kunitachi-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/105,365

(22) Filed: Mar. 26, 2002

(30) Foreign Application Priority Data
Mar. 28, 2001 (JP) 2001-093863

(51) Int. Cl. G09G 3/36

(52) U.S. Cl. 345/89

(57) ABSTRACT

Disclosed is a method of adjusting a liquid crystal display device including a liquid crystal display panel having a liquid crystal layer, and a control portion which controls a display state of the liquid crystal display panel, the method comprising preparing plural kinds of gradation information concerning correlation between voltages to be applied to the liquid crystal layer and gradations of display in the liquid crystal display panel, and selecting desired gradation information from the plural kinds of gradation information to set the desired information in the control portion.

### CROSS-REFERENCE TO RELATED APPLICATIONS

This application is based upon and claims the benefit of priority from the prior Japanese Patent Application No. 2001-093863, filed Mar. 28, 2001, the entire contents of which are incorporated herein by reference.

### BACKGROUND OF THE INVENTION

1. Field of the Invention

The present invention relates to a liquid crystal display device and a method of adjusting the same.

2. Description of the Related Art

In a liquid crystal display device performing gradation display, generally a single gradation palette is set in a controller, and display contrast is adjusted by changing a driving voltage of the liquid crystal by an electronic volume in the controller. Specifically, in a conventional liquid crystal display device, a display state is optimized only by adjusting the electronic volume, in the state where the gradation palette is fixed.

However, if the driving voltage is changed, a brightness range of the liquid crystal display panel changes. Therefore, even if the gradation palette has been optimized in a certain driving voltage, it is feared that optimality of the gradation is spoiled by changing the driving voltage. Further, since the electronic volume is used, the driving voltage can only have discontinuous values. Therefore, it is impossible to perform fine adjustment of the driving voltage so as to be adapted to a fixed optimum gradation palette.

Further, also in the case of performing color display, a gradation palette whose color balance is optimized at a specific voltage is used, and only adjustment of the electronic volume is performed with the gradation palette fixed. Therefore, changing the driving voltage by the electronic volume causes the problem of losing the color balance.

As described above, in conventional liquid crystal display devices, the gradation palette is fixed and only adjustment by the electronic volume is performed, which causes the case where the gradation cannot be properly adjusted, and causes a problem of incurring deterioration of the display quality.

The present invention is aimed at providing a liquid crystal display device and a method of adjusting the same, which can achieve appropriate gradation and improve the display quality.

### BRIEF SUMMARY OF THE INVENTION

According to a first aspect of the present invention, there is provided a method of adjusting a liquid crystal display device including: a liquid crystal display panel having a liquid crystal layer; and a control portion which controls a display state of the liquid crystal display panel, the method comprising: preparing plural kinds of gradation information concerning correlation between voltages to be applied to the liquid crystal layer and gradations of display in the liquid crystal display panel; and selecting desired gradation information from the plural kinds of gradation information to set the desired information in the control portion.

According to a second aspect of the present invention, there is provided a liquid crystal display device comprising: a liquid crystal display panel having a liquid crystal layer; a control portion which controls a display state of the liquid crystal display panel; a storing portion storing plural kinds of gradation information concerning correlation between voltages to be applied to the liquid crystal layer and gradations of display in the liquid crystal display panel; and a selecting portion which selects desired gradation information from the plural kinds of gradation information to set the desired gradation information in the control portion.

According to a third aspect of the present invention, there is provided a liquid crystal display device comprising: a liquid crystal display panel having a liquid crystal layer and a predetermined maximum brightness range; and a holding portion holding gradation information concerning correlation between voltages to be applied to the liquid crystal layer and gradation levels of display in the liquid crystal display panel, wherein the gradation levels are converted from respective standard gradation levels obtained by dividing the predetermined maximum brightness range, and a difference between the gradation levels and the respective standard gradation levels increases or decreases as the gradation level rises.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing an example of a structure of a liquid crystal display device according to an embodiment of the present invention.

FIG. 2 is a diagram showing an example of a gradation palette in the case of using a standard driving voltage (Vstd).

FIG. 3 is a diagram for explaining the gradation palette shown in FIG. 2.

FIG. 4 is a diagram relating to prior art, showing an example of a gradation palette in the case where the driving voltage is Vn.

FIG. 5 is a diagram for explaining the gradation palette shown in FIG. 4.

FIG. 6 is a diagram relating to the embodiment of the present invention, and showing an example of a gradation palette in the case where the driving voltage is Vn.

FIG. 7 is a diagram for explaining the gradation palette shown in FIG. 6.

FIG. 8 is a diagram showing a modification of a gradation palette according to the embodiment of the present invention.

FIG. 9 is a diagram for explaining the gradation palette shown in FIG. 8.

### DETAILED DESCRIPTION OF THE INVENTION

An embodiment of the present invention will now be described with reference to the drawings.

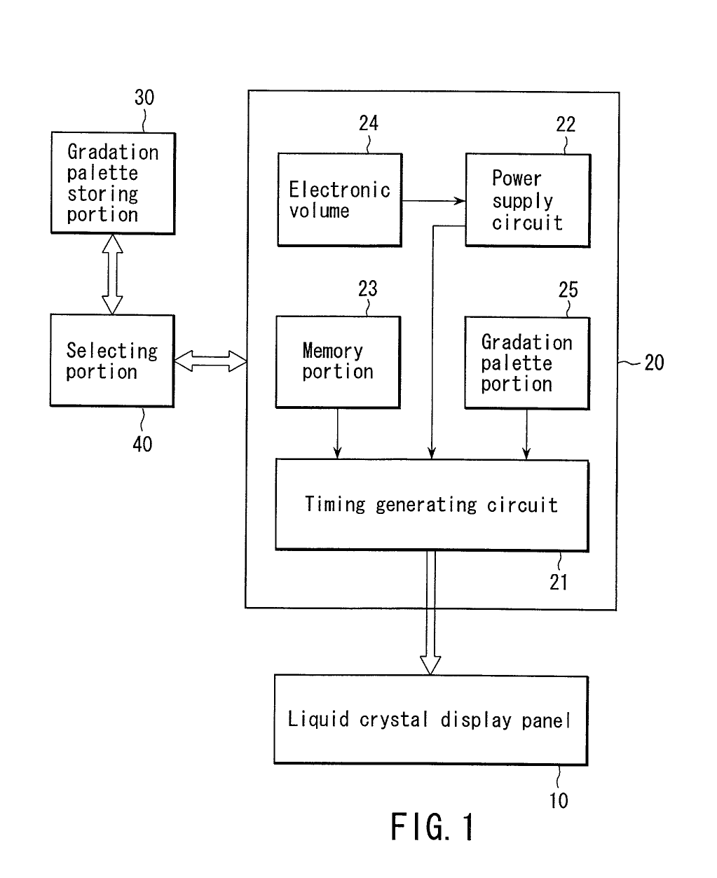

FIG. 1 is a block diagram showing an example of a structure of a liquid crystal display device according to an embodiment of the present invention.

As a liquid crystal display panel 10, a matrix-type panel is used, in which a pixel is formed in each part where one of plural common electrodes (scanning lines) and one of plural segment electrodes (signal lines) cross. By applying respective voltages to the common electrodes and segment electrodes, the display state (transmittance) of the liquid crystal held between the electrodes is controlled.

A liquid crystal controller 20 including a timing generating circuit 21, a power supply circuit 22, a memory portion 23, an electronic volume 24 and a gradation palette portion 25 is connected to the liquid crystal display panel 10. The liquid crystal controller 20 controls the display state of the liquid crystal display panel 10.

The timing generating circuit 21 is used for supplying respective voltage signals, at a predetermined timing, to the common electrodes and segment electrodes of the liquid crystal display panel 10. A basic driving method by the timing generating circuit 21 is similar to a common driving method in a matrix-type liquid crystal display panel. Specifically, the common electrodes are successively scanned to supply them with selective signals, and selective signals or non-selective signals are supplied to the segment electrodes in synchronization with the scanning timing of the common electrodes, thereby an effective voltage to be applied to the liquid crystal is changed.

The power supply circuit 22 is connected to the timing generating circuit 21. The timing generating circuit 21 forms voltage signals to be applied to the common electrodes and the segment electrodes, on the basis of various voltages supplied from the power supply circuit 22. Further, the memory portion 23 is connected to the timing generating circuit 21. Display on the liquid crystal display panel 10 is performed on the basis of image information stored in the memory portion 23.

The electronic volume 24 is connected to the power supply circuit 22. The electronic volume 24 discontinuously changes the driving voltage of the liquid crystal. By adjusting the electronic volume 24, the display brightness range of the liquid crystal display panel 10 changes, and the contrast is adjusted. Specifically, the electronic volume 24 can change the magnitude of the voltage (level of the voltage) to be applied to the liquid crystal display panel 10.

The gradation palette portion 25 holds gradation palette information which determines correlation between the effective voltage to be applied to the liquid crystal and the gradation. The gradation palette information in the gradation palette portion 25 is rewritable. Therefore, when the liquid crystal display panel 10 is adjusted, it is possible to set a desired gradation palette in the gradation palette portion 25 in accordance with the driving voltage.

A rewriting of the gradation palette portion 25 is performed by a gradation palette storing portion 30 and a selecting portion 40 (constituted by a microcomputer, for example). The gradation palette storing portion 30 stores plural kinds of gradation palette information formed in advance. When the liquid crystal display panel 10 is adjusted, a desired gradation palette can be set in the gradation palette portion 25 by selecting the desired gradation palette from the gradation palette storing portion 30 by the selecting portion 40.

Adjustment of the display state of the liquid crystal display panel 10 can be divided broadly into two categories. The first category is adjustment at the stage of shipping from factories. In such a case, the liquid crystal display device includes the liquid crystal display panel 10 and the liquid crystal controller 20. The second category is adjustment by users. In this case, the liquid crystal display device includes the liquid crystal display panel 10, the liquid crystal controller 20, the gradation palette storing portion 30 and selecting portion 40.

Next, a method of adjusting the liquid crystal display panel, using the device shown in FIG. 1, will now be described.

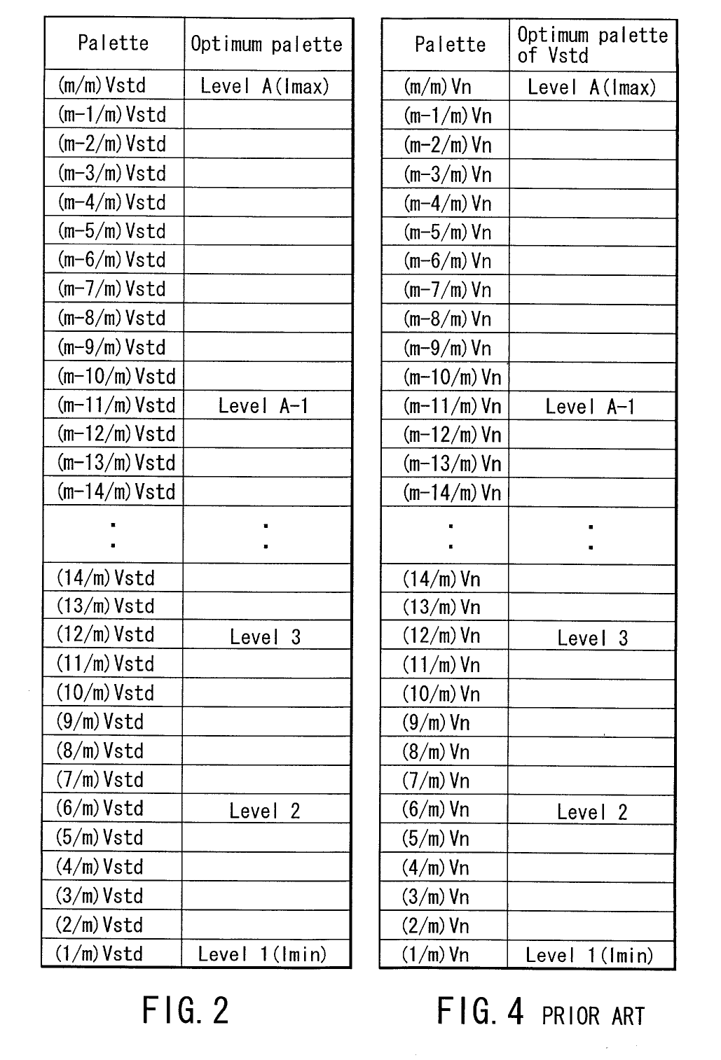

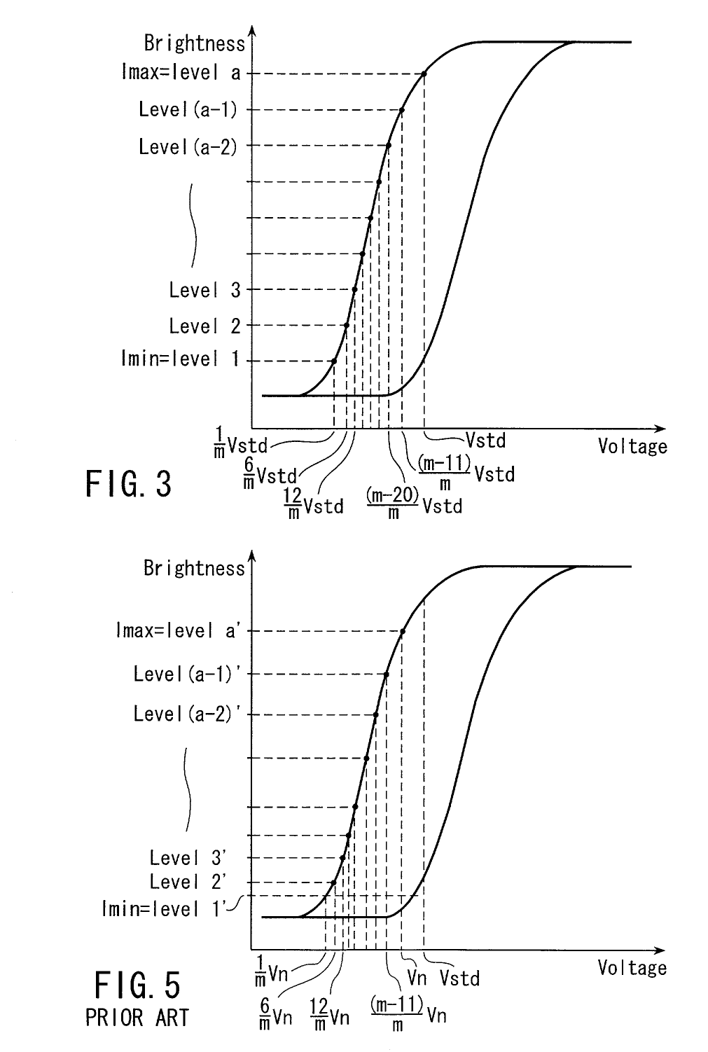

FIG. 2 is a diagram showing an example of a gradation palette in the case of using a standard driving voltage (Vstd). FIG. 3 shows the correlation shown in FIG. 2 on a display characteristic diagram (a diagram showing the relation between the effective voltage and the brightness) of the liquid crystal. In FIG. 3, the horizontal axis represents the effective voltage applied to the liquid crystal, and the vertical axis represents the display brightness (corresponding to transmittance of the liquid crystal).

As shown in FIGS. 2 and 3, the gradation levels are correlated with respective voltage information, such that intervals between the gradation levels (brightness levels) from the minimum brightness Imin to the maximum brightness Imax are equal. In the example shown in FIGS. 2 and 3, the gradation levels are correlated with respective voltage information, for example, the voltage (1/m) Vstd is correlated with level 1 and the voltage (6/m) Vstd is correlated with level 2, . . . .

Although good gradation display can be obtained as described above in the case of using the standard driving voltage Vstd, there are the cases where it is required to change the driving voltage in accordance with change of manufacture lot, etc. Further, since the electronic volume changes the driving voltage, there are the cases where the driving voltage cannot be set to the standard driving voltage Vstd. The case where the driving voltage is set to a voltage Vn, which is different from the standard driving voltage Vstd, will now be described in comparison with a comparative example according to prior art.

FIG. 4 is a diagram relating to a comparative example (prior art), showing an example of a gradation palette in the case where the driving voltage is Vn. FIG. 5 is a diagram showing the correlation shown in FIG. 4 on a display characteristic diagram of the liquid crystal.

In the prior art, since only a single gradation palette is used, even when the driving voltage is changed, the same gradation palette is used. Therefore, as shown in FIGS. 4 and 5, intervals between the gradation levels (brightness levels) are nonuniform. In the example shown in FIGS. 4 and 5, intervals between the gradation levels narrow on the low-brightness side, and intervals between gradation levels broaden on the high-brightness side. As a result, gradation quality is greatly deteriorated.

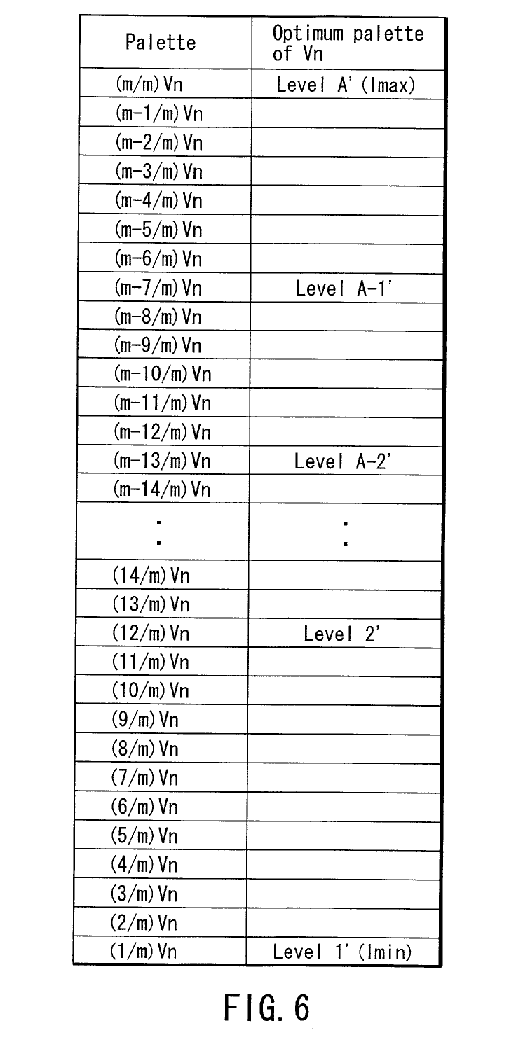

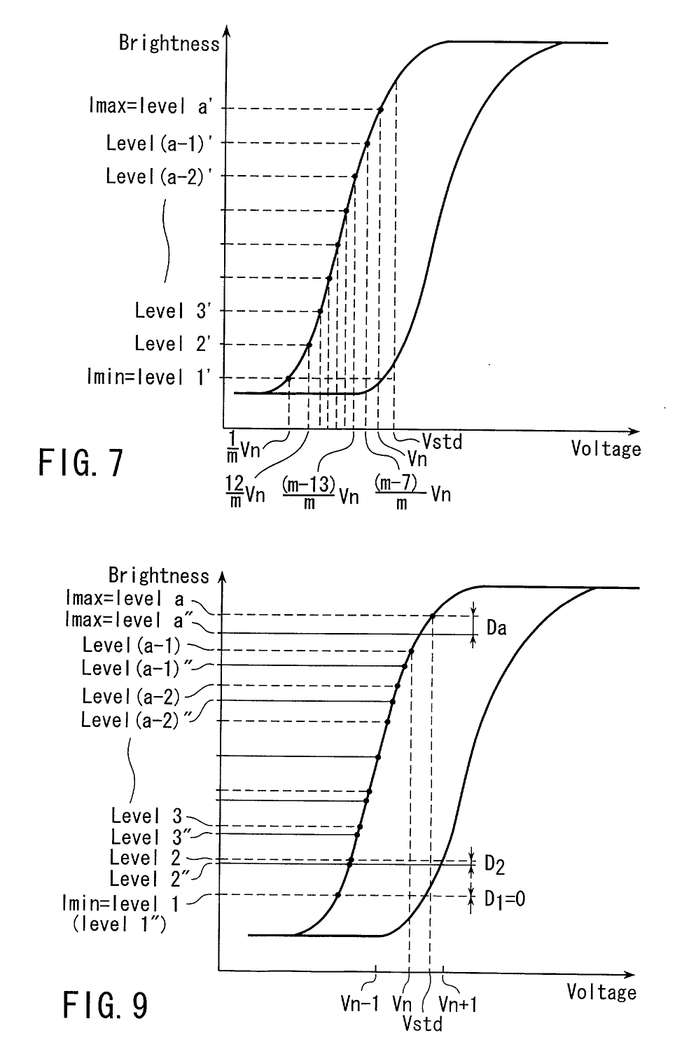

FIG. 6 is a diagram relating to the embodiment of the present invention, showing an example of a gradation palette in the case where the driving voltage is Vn. FIG. 7 is a diagram showing the correlation shown in FIG. 6 on a display characteristic diagram of the liquid crystal.

In the embodiment of the present invention, a gradation palette suitable for the driving voltage (Vn) is selected from plural gradation palettes stored in the gradation palette storing portion 30, and set in the gradation palette portion 25. Therefore, intervals between the gradation levels from the minimum brightness Imin (level 1′) to the maximum brightness Imax (level A′) can be equalized.

As described above, in the embodiment of the present invention, a desired gradation palette is selected according to the driving voltage set by the electronic volume. Therefore, it is possible to always set an optimum gradation palette regardless of the driving voltage. Thus, it is possible to uniformize the display quality between liquid crystal display panels, and perform an appropriate gradation display. Further, although the driving voltage which can be set is discontinuous since the electronic volume is used, it is possible to suppress deterioration in the display due to discontinuity of the driving voltage, by preparing plural gradation palettes suitable for the driving voltage which can be set by the electronic volume.

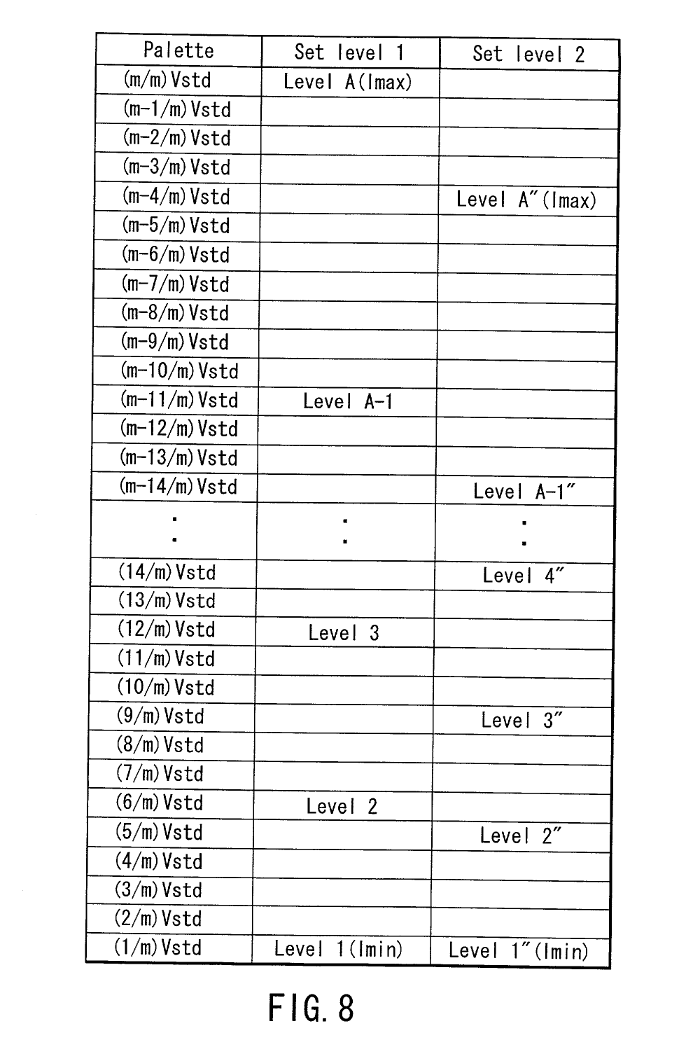

FIGS. 8 and 9 show another example of the method of adjusting a liquid crystal display panel by using the device shown in FIG. 1. In this example, plural gradation levels corresponding to plural standard gradation levels obtained by dividing the predetermined maximum brightness range are set, and the set plural gradation levels are used as a gradation palette. The upper limit and lower limit of the above predetermined maximum brightness range do not always correspond to the maximum brightness (maximum transmittance) and the minimum brightness (minimum transmittance) of the liquid crystal display panel respectively. For example, the maximum brightness range is predetermined to be within 10 to 90% of the maximum brightness of the liquid crystal display panel.

Specifically, a gradation palette obtained by converting the levels 1 to A in the standard driving voltage (Vstd) into level 1″ (=level 1) to level A″ is prepared. In the example shown in FIGS. 8 and 9, the gradation palette is set such that the difference in brightness (D1 to Da in FIG. 9) between the gradation levels at the standard driving voltage and the corresponding converted gradation levels gradually increases from D1 toward Da, that is, toward the high-brightness side. Conversely, the gradation palette may be set such that the difference in gradation between adjacent gradation levels gradually decreases as the gradation level rises. Further, level A″ may be set to be equal to level A instead of level 1″=level 1. In such a case, the gradation palette may be set such that the difference in brightness between the gradation levels at the standard driving voltage and the corresponding converted gradation levels gradually increases toward the low-brightness side. Conversely, the gradation palette may be set such that the difference in gradation between adjacent gradation levels gradually decreases as the gradation level lowers.

By performing adjustment with the gradation palette set as described above, it is possible to perform display as if the whole display brightness had changed (in the example of FIGS. 8 and 9, display is performed as if the whole display brightness had been shifted to the low-brightness side). Therefore, it is possible to equivalently perform brightness adjustment of the liquid crystal display panel without using the electronic volume.

The method of the embodiment described above is also applicable to adjustment of color display. Specifically, plural gradation palettes are prepared for each of the three primary colors (RGB), and a proper gradation palette is selected from the plural gradation palettes for each primary color, and thereby dispersion of color tone, etc. can be precisely adjusted. For example, excellent reproduction of white color and flesh color can be obtained by selecting a proper gradation palette for each primary color. Further, it is also possible to obtain a desired color tone (reddish tone and bluish tone) by selecting a proper gradation palette for each primary color to adjust RGB balance.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of adjusting a liquid crystal display device including: a liquid crystal display panel having a liquid crystal layer; and a control portion which controls a display state of the liquid crystal display panel, the method comprising:
preparing plural kinds of gradation information concerning correlation between voltages to be applied to the liquid crystal layer and gradations of display in the liquid crystal display panel; and
selecting desired gradation information from the plural kinds of gradation information to set the desired information in the control portion.

2. A method according to claim 1, wherein the desired gradation information is selected when a voltage to be applied to the liquid crystal layer is changed.

3. A method according to claim 1, wherein the plural kinds of gradation information are prepared for each primary color, and desired gradation information is selected from the plural kinds of gradation information for each primary color.

4. A liquid crystal display device comprising:
a liquid crystal display panel having a liquid crystal layer;
a control portion which controls a display state of the liquid crystal display panel;
a storing portion storing plural kinds of gradation information concerning correlation between voltages to be applied to the liquid crystal layer and gradations of display in the liquid crystal display panel; and
a selecting portion which selects desired gradation information from the plural kinds of gradation information to set the desired gradation information in the control portion.

5. A liquid crystal display device according to claim 4, wherein the desired gradation information is selected when a voltage to be applied to the liquid crystal layer is changed.

6. A liquid crystal display device according to claim 4, wherein the storing portion stores the plural kinds of gradation information for each primary color, and the selecting portion selects desired gradation information from the plural kinds of gradation information for each primary color.

7. A liquid crystal display device comprising:
a liquid crystal display panel having a liquid crystal layer and a predetermined maximum brightness range; and
a holding portion holding gradation information concerning correlation between voltages to be applied to the liquid crystal layer and gradation levels of display in the liquid crystal display panel, wherein
the gradation levels are converted from respective standard gradation levels obtained by dividing the predetermined maximum brightness range, and a difference between the gradation levels and the respective standard gradation levels increases or decreases as the gradation level rises.
